(19) United States
(12) Patent Application Publication
(10) Pub. No.: US 2016/0218663 A1
(43) Pub. Date: Jul. 28, 2016

(54) Solar Photovoltaic Single Axis Tracker

(71) Applicants: Mark Francis WERNER, Lasalle (CA); Michael Gregory ZUZELSKI, Beverly Hills, MI (US); MAGNA INTERNATIONAL INC., Aurora (CA)

(72) Inventors: Mark Francis Werner, Lasalle (CA); Mattias Peter Woletz, Clawson, MI (US); Michael Gregory Zuzelski, Beverly Hills, MI (US)

(21) Appl. No.: 15/025,265

(22) PCT Filed: Oct. 3, 2014
(86) PCT No.: PCT/US14/59087

§ 371 Date: Mar. 26, 2016

Related U.S. Application Data
(60) Provisional application No. 61/887,348, filed on Oct. 5, 2013.

(51) Int. Cl. H02S 20/32

(52) U.S. Cl. CPC H02S 20/32

(57) ABSTRACT

An improved solar panel assembly is provided. The assembly includes a plurality of sub-assemblies which are spaced from one another. Each sub-assembly has at least two torque tubes and a plurality of laterally spaced rails which are coupled with the torque tubes for supporting a plurality of solar panels or reflectors thereon. Rotation of the torque tubes about the lateral axis rotates the solar panels or the reflectors mounted on the rails. At least one torque arm is joined with and extends transversely away from one of the torque tubes of each sub-assembly. A driveshaft extends longitudinally between the sub-assemblies and is moveable in the longitudinal direction for rotating the solar panels or reflectors via the torque arms, the torque tubes and the rails. The torque tubes are generally cylindrical in shape and adjacent torque tubes of each sub-assembly are co-axially joined in an end-to-end relationship with one another.

### CROSS-REFERENCE TO PRIOR APPLICATIONS

This PCT Patent Application claims the benefit of U.S. Provisional Patent Application Ser. No. 61/887,348 filed Oct. 5, 2013, entitled “Solar Photovoltaic Single Axis Tracker,” the entire disclosure of the application being considered part of the disclosure of this application and hereby incorporated by reference.

### BACKGROUND OF THE INVENTION

1. Field of the Invention

The present invention relates generally to support frame assemblies for solar related devices.

2. Related Art

Solar trackers are devices which include a plurality of solar panels and (such as, for example, photovoltaic panels, reflectors, lenses or other optical devices) are operable to automatically adjust the orientations of those panels throughout each day to maximize the amount of solar rays captured or reflected by the solar panels. Solar trackers generally have a support frame assembly which engages and supports the solar panels. Typically, each support frame assembly has its own actuator for adjusting orientations of the solar panels.

Other types of solar trackers have a driveshaft which extends between and is operably connected to a plurality of sub-assemblies, each of which has a support frame assembly and a plurality of solar panels. Each sub-assembly includes a torque tube which supports the solar panels and a torque arm which interconnects the torque tube with the driveshaft. In operation, an actuator moves the driveshaft through a generally arcuate path, and this motion is translated through the torque arms into the torque tubes to rotate solar panels. As such, the single actuator simultaneously adjusts the orientations of the solar panels of a plurality of sub-assemblies that are spaced from one another.

There remains a significant and continuing need for a more efficient and less costly solar tracker.

### SUMMARY OF THE INVENTION AND ADVANTAGES

One aspect of the present invention provides for an improved solar panel assembly including a plurality of sub-assemblies which are spaced from one another in a longitudinal direction. Each of the sub-assemblies includes at least two torque tubes which extend in a lateral direction that is generally transverse to said longitudinal direction. Each of the sub-assemblies further includes a plurality of laterally spaced rails which are coupled with the torque tubes for supporting a plurality of solar panels or reflectors thereon. Rotation of the torque tubes about the lateral axis rotates the solar panels or the reflectors mounted on the rails. At least one torque arm is joined with and extends transversely away from one of the torque tubes of each sub-assembly. A driveshaft extends longitudinally between the sub-assemblies and is moveable in the longitudinal direction for rotating the solar panels or reflectors via the torque arms and the torque tubes and the rails. The torque tubes are generally cylindrical in shape and adjacent torque tubes of each sub-assembly are co-axially joined in an end-to-end relationship with one another.

The cylindrical shape of the torque tubes allows the torque tubes to be joined with one another with any circumferential alignment which allows for easier assembly of the parts of the solar assembly in the field. The torque tubes may also be formed more cost effectively than torque tubes of other non-cylindrical shapes.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a perspective and elevation view of an exemplary solar tracker assembly;

FIG. 2 is an enlarged perspective and fragmentary view of the exemplary solar tracker assembly of FIG. 1;

FIG. 3 is an enlarged perspective and fragmentary view of a portion of the exemplary solar tracker assembly of FIG. 1;

FIG. 4 is a perspective and elevation view of an exemplary spherical bearing assembly;

FIG. 5 is a perspective, fragmentary and elevation view of the exemplary spherical bearing of FIG. 4 showing a pair of races being supported in a lower shell;

FIG. 6 is a perspective and fragmentary view of the exemplary spherical bearing of FIG. 4 and showing a single race being supported in the lower shell;

FIG. 7 is a perspective and elevation view of one of the races;

FIG. 8 is a perspective and elevation view of the other of the races;

FIG. 9 is an enlarged and fragmentary view showing the connection between adjacent torque tubes of the exemplary solar tracker assembly of FIG. 1;

FIG. 10 is an enlarged and fragmentary view showing the connection between rails and a torque tube in the exemplary solar tracker assembly of FIG. 1; and

FIG. 11 is an enlarged and perspective view showing an exemplary braking mechanism for restricting movement of a driveshaft.

### DESCRIPTION OF THE ENABLING EMBODIMENT

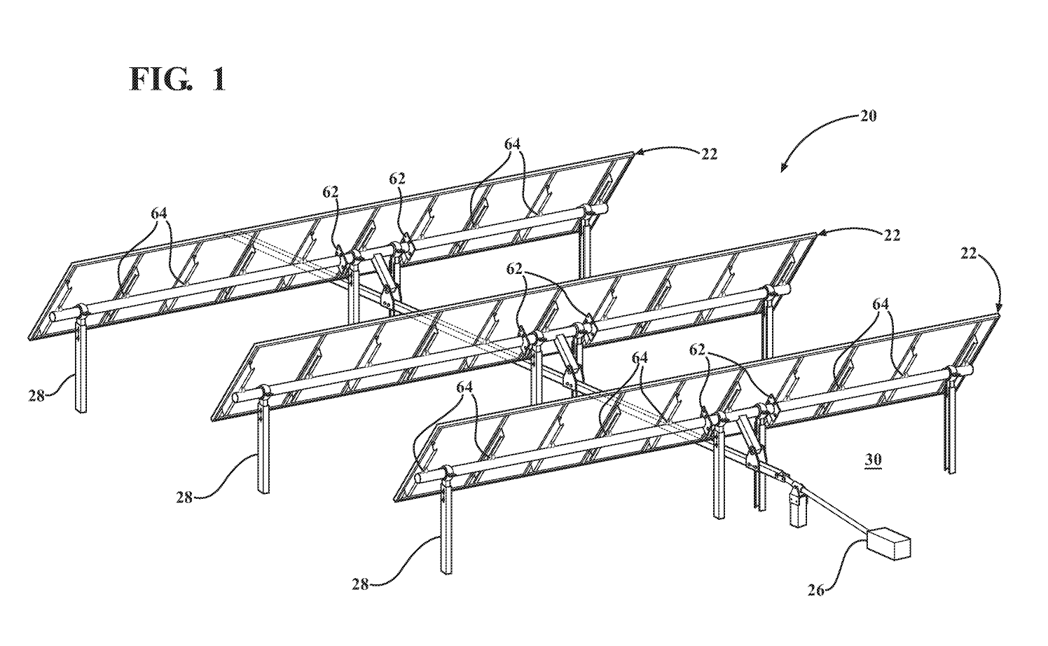

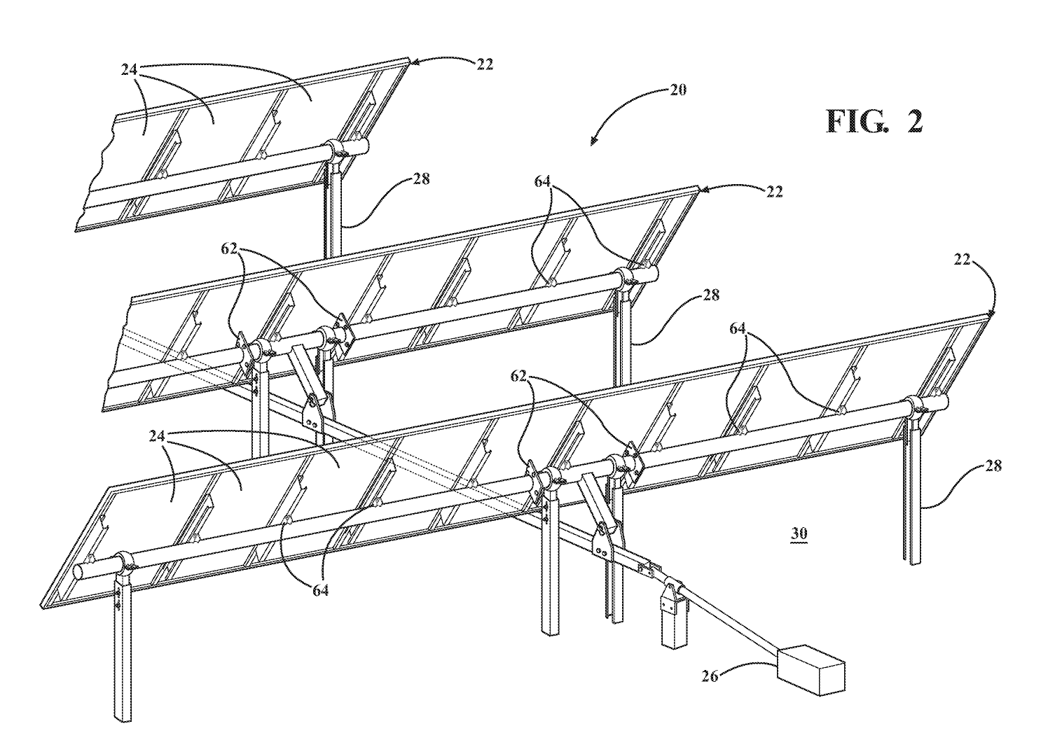

Referring to the Figures, wherein like numerals indicate corresponding parts throughout the several views, an exemplary embodiment of a solar tracker assembly 20 is generally shown in FIG. 1. As shown, the solar tracker assembly 20 includes a plurality of sub-assemblies 22 (nine being shown in the exemplary embodiment) which are spaced from one another in a longitudinal direction. The longitudinal direction could be a north-south direction, an east-west direction or any desirable direction. As best shown in FIG. 2, each of the exemplary sub-assemblies 22 has its own array of photovoltaic panels 24, or cells, for harnessing the potential energy in solar rays and generating electricity. As shown, the arrays of the different sub-assemblies 22 are all arranged to face in the same general direction, and as will be discussed in further detail below, the sub-assemblies 22 are all mechanically connected to one another so that a single driving unit or actuator 26 can simultaneously adjust the orientations of the photovoltaic panels 24 of all of the sub-assemblies 22. As such, the single actuator 26 is operative to adjust the sub-assemblies 22 such that the photovoltaic panels 24 simultaneously “follow the sun” as it figuratively travels across the sky during each day to increase the total amount of solar rays harnessed and the total amount of electricity generated by the photovoltaic panels 24 each day as compared to stationary/non-moveable photovoltaic panels. Although photovoltaic panels 24 are employed in the exemplary embodiment, it should be appreciated that the sub-assemblies 22 could include mirrors or any suitable type of solar reflecting or collecting in place of or in addition to the photovoltaic panels 24 shown in the exemplary embodiment.

Referring still to FIG. 2, each of the sub-assemblies 22 includes a frame structure 28 which supports the photovoltaic panels 24 above a base 30, such as the ground, a platform or a roof of a building. Referring now to FIG. 3, as will be discussed in further detail below, each of the frame structures 28 includes a plurality of support posts 32 which extend vertically upwardly from the base 30 (shown in FIGS. 1 and 2), a plurality of bearings 34 which are positioned at the upper ends of the support posts 32, a plurality of torque tubes 36 which extend between the bearings 34 and a plurality of rails 38 which support the photovoltaic panels 24. The bearings 34 allow rotation of the torque tubes 26 which drives rotation of the photovoltaic panels 24 via the rails 38.

The support posts 32 of the frame structures 28 are anchored to the base 30, and the support posts 32 of each subassembly 22 are spaced apart from one another in a lateral direction which is perpendicular to the aforementioned longitudinal direction. The support posts 32 of the exemplary embodiment are made of metal and are generally C-shaped in cross-section, and each support post 32 has a pair of vertically extending slots 40 adjacent their upper ends for attaching the bearings 34 with the support posts 32.

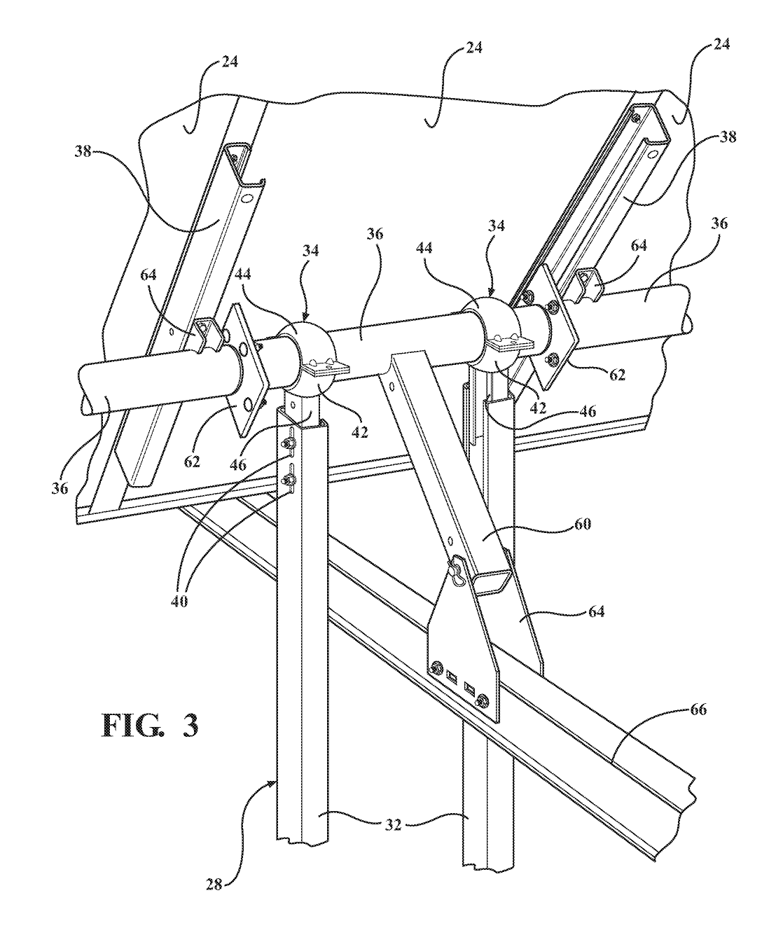

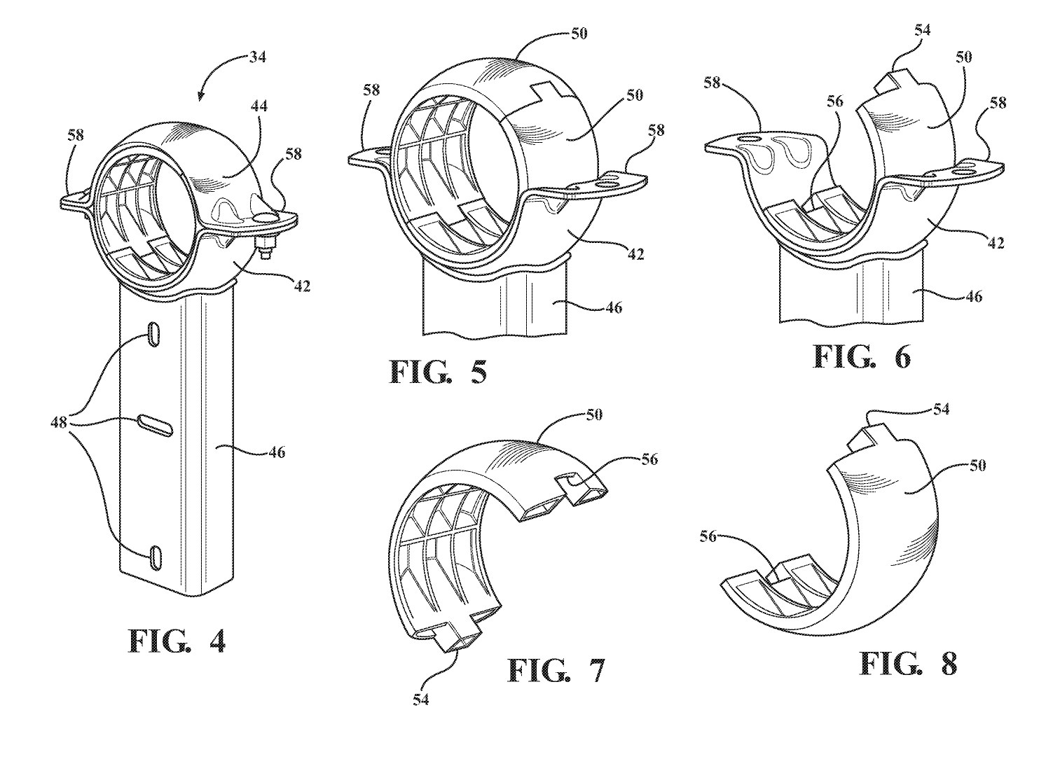

Referring now to FIGS. 4-8, an exemplary one of the bearings 34 is shown. As shown, each of the bearings 34 includes a lower shell 42 and an upper shell 44, each of which has a semi-spherical outer surface and a semi-spherical inner surface. In the exemplary embodiment, the lower and upper shells 44, 42 are of identical shape and construction, which allows for reduced manufacturing costs through economies of scale. Each of the lower shells 42 is connected (for example, through welding) to the top of a bearing post 46 which has a plurality of apertures 48 that are spaced vertically from the lower shell 42. While some of the components of the solar tracker assembly must be assembled in the field, the lower shells 42 may be attached to the bearing posts 46 in a factory setting and shipped as a pre-assembled unit to an installation site. The apertures 48 in the bearing posts 46 are for connecting the bearing posts 46 with the aforementioned support posts 32 (shown in FIG. 3) via fasteners, such as bolts. Specifically, the bearings 34 are interconnected with the support posts 32 by aligning the apertures 48 of the bearing posts 46 with the slots 40 in the support posts 32 and inserting fasteners through the aligned apertures 48 and slots 40. This type of connection is particularly advantageous because it may be established in the field in a very quick manner and without any special equipment. Additionally, the slots 40 in the support posts 32 allow for the heights of the bearings 34 relative to the base 30 to be established in the field and to be easily adjusted if needed. For bases 30 having uneven terrain, this may be particularly advantageous since it allows the photovoltaic panels 24 of each sub-assembly 22 to be held at generally constant levels. It should be appreciated that the slots could be in the bearing posts 46 in addition to or in lieu of the slots 40 in the support posts 32.

Referring now to FIGS. 5-8, each of the bearings 34 further includes a pair of races 50 which, like the lower and upper shells 42, 44 are also of identical construction with one another. Each of the races 50 has a tongue 54 on one side and a recess 56, which is shaped similarly to the tongue 54, on the other side. In the exemplary embodiment, the races 50 lack have any latches or any other features for locking into engagement with one another. However, such features could be included, if desired. The lower and upper shells 42, 44 have radially outwardly extending flanges 58, and the flanges 58 of the upper shell 44 are connectable to the flanges 58 of the lower shell 42 to trap the first and second races 50 within the confines established by the spherical inner surfaces of the lower and upper shells 42, 44. In the exemplary embodiment, the flanges 58 of the lower and upper shells 42, 44 are connected together with fasteners. However, any suitable releasable or permanent connection means may alternately be employed.

The races 50 have generally smooth, continuous, and semi-spherical outer surfaces to provide for low-friction contact surfaces between the races 50 and the semi-spherical inner surfaces of the lower and upper shells 42, 44. The races 50 also have grids on their inner sides for structural strengthening purposes. The races 50 are preferably made of a self-lubricating and low-friction material, such as Acetal Co-Polymer to provide a low friction contact surface between the shells 42, 44 and the races 50. In contrast to cylindrical bearings, which are found in many known solar tracker assemblies, the spherical bearings 34 of the exemplary embodiment compensate for some degree in the rotational variations of the support posts 32 and also may reduce stress at the bearings 34 from wind loading by providing for additional compliance in the joint due to the additional degrees of freedom allowed by the spherical design.

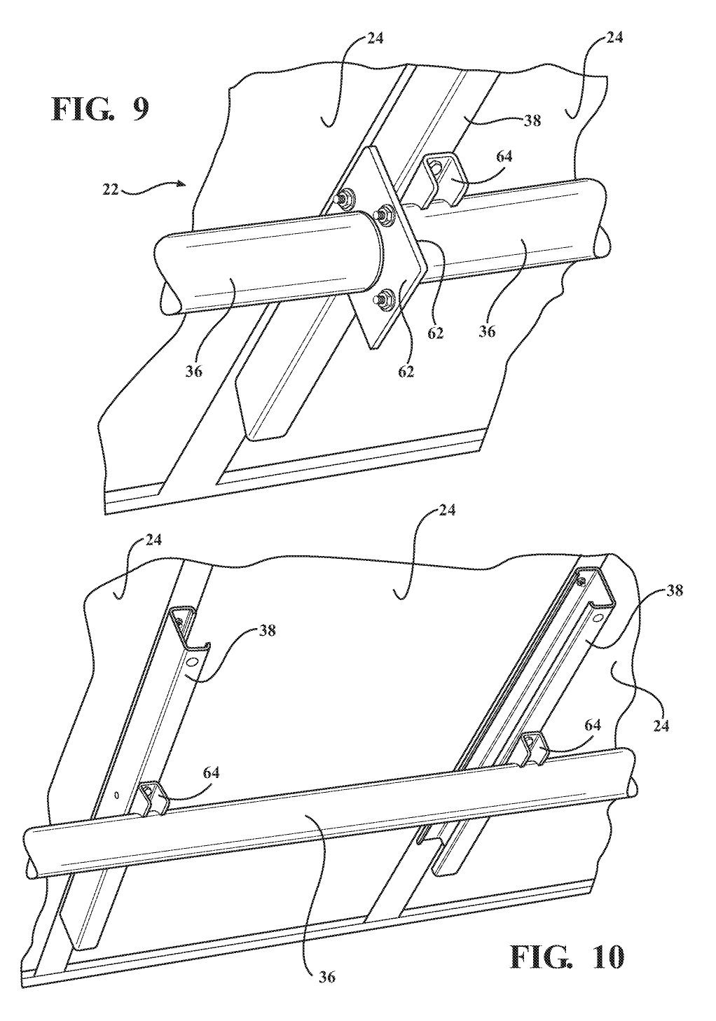

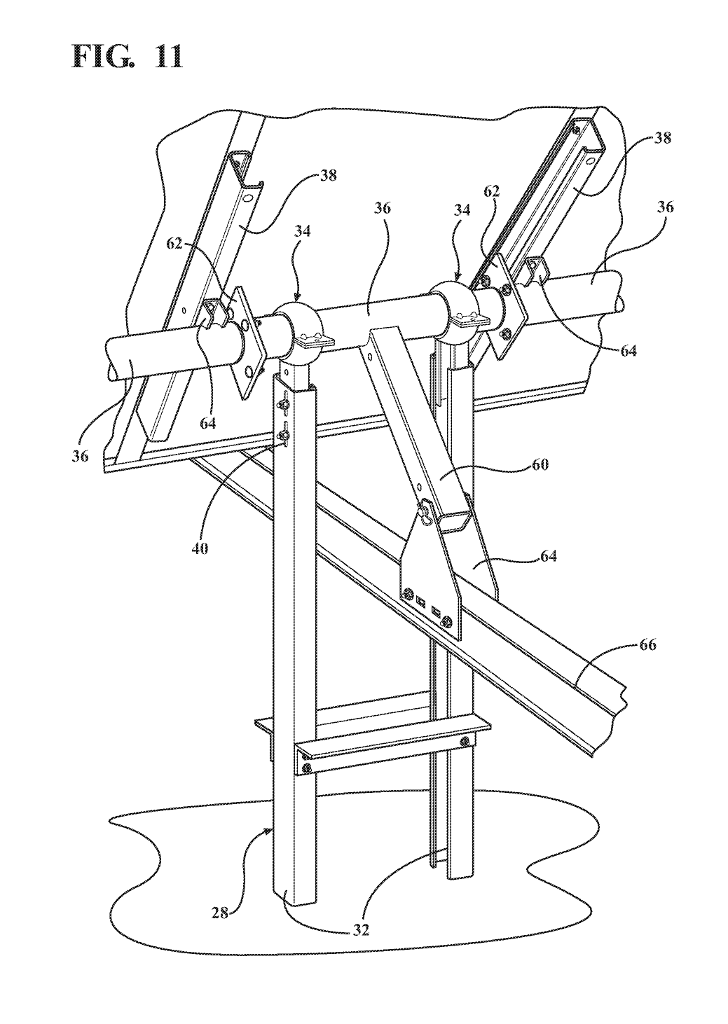

Referring now to FIG. 9, each of the sub-assemblies 22 has a plurality of torque tubes 36 which are attached with one another in a co-axial fashion with adjacent ends of the torque tubes 36 being joined with one another such that all of the torque tubes 36 may rotate simultaneously with one another. In the exemplary embodiment of the solar assembly, the adjacent ends of the torque tubes 36 have generally flat and rectangularly-shaped plates 62 attached to their ends (e.g., through welding in a factory setting), and the plates 62 of adjacent torque tubes 36 are bolted to one another to establish the connection between the adjacent torque tubes 36. This allows shorter torque tubes 36 to be constructed in a factory setting and shipped out to the field where they may then be quickly connected with one another without any welding or other special equipment. It should be appreciated that other connection means, such as brazing or fasteners, may alternately be employed to secure the plates 62 to the ends of the torque tubes 36.

Referring still to FIG. 9, in the exemplary embodiment, the torque tubes 36 are generally circular in cross-section, which allows for increased freedom when attaching the plates 62 to the ends of the torque tubes 36 as compared to square torque tubes of other such solar assemblies. As such, a particular rotational alignment between the plates 62 of the opposite ends of the torque tubes 36 relative to one another and to the torque tubes 36 is not required. This allows connection of the torque tubes 36 to be accomplished more simply and at a lower cost than if the torque tubes were non-circular.

Referring back to FIG. 3, the rails 38 of the frame structures 28 are spaced in a lateral direction from one another and are interconnected with the torque tubes 36 via brackets 64. In the exemplary embodiment, the brackets 64 have a pair of arcuate edges which are connected to the torque tubes 36 through welding but could be welded or otherwise attached to the torque tubes 36 through any suitable manner. The brackets 64 may be connected with the torque tubes 36 in a factory setting before the torque tubes 36 are shipped to the field. This allows for the brackets 64 to be more precisely positioned and oriented along the torque tube 36. In the exemplary embodiment, each rail 38 is disposed between a pair of photovoltaic panels 24 and supports the adjacent lateral edges of those panels 24. In the exemplary embodiment, the photovoltaic panels 24 are mounted in a portrait orientation but could alternately be oriented in a landscape orientation.

An exemplary process for assembling the sub-assemblies 22 of the exemplary embodiment in the field begins with anchoring the support posts 32 to the base 30 such that the support posts 32 extend generally vertically upwardly from the base 30. Next, the bearing posts 46, which are attached to the lower shells 42, are joined to the support posts 32 with fasteners, such as bolts such that the inner surfaces of the lower shells 42 face upwardly. Then, the races 50 are placed around the torque tubes 36 and set into the upwardly facing spherical inner surfaces of the lower shells 42. To secure the torque tubes 36 with the bearings 34, the flanges 58 on the upper shells 44 of the bearings 34 are then secured to the flanges 58 on the lower shells 42. With this, the torque tubes 36 are supported above the support posts 32 by the bearings 34 and may rotate relative to the base 30. The races 50 of the bearings 34 may be stationary relative to either the first and second shells 42, 44 or to the torque tubes 36 during rotation of the torque tubes 36. The rails 38 may then be secured to the brackets 64 on the torque tubes 36 and the plates 62 on adjacent torque tubes 36 may be secured to one another with, for example, fasteners. All of these steps may be accomplished quickly and without any welding equipment or other special tools.

Once the photovoltaic panels 24 are installed on the rails 38 of the frame structure 28, the torque tubes 36 allow them to simultaneously and uniformly rotate relative to the base 30, thereby allowing the photovoltaic panels 24 to “follow the sun” as it travels across the sky during each day to increase the total amount of solar rays that are harnessed and the total amount of electricity that is generated.

As shown in FIG. 3, each of the sub-assemblies 22 additionally includes a torque arm 60 which is interconnected with a middle torque tube 36a that is shorter than the other torsion tubes 36b. The torque arms 60 are preferably attached directly to the middle torque tubes 36 through welding in a factory setting. However, the torque arms 60 could alternately be connected with the middle torque tubes 36 through brazing, adhesives, mechanical fasteners, etc. As discussed in further detail below, the torque arms 60 on the sub-assemblies 22 are mechanically connected to one another through a driveshaft 66 for simultaneously rotating all of the photovoltaic panels 24 of all of the sub-assemblies 22.

Referring still to FIG. 3, the end of each torque arm 60 opposite of the middle torque tube 36a is attached via a bracket 64 to an elongated driveshaft 66 which extends in the longitudinal direction between all of the sub-assemblies 22 (see FIG. 1). The bracket 64 of the exemplary embodiment is a pair of plates that are generally triangularly shaped when viewed from one side. The bracket 64 is preferably attached to the torque arm 60 with a cleavis pin/cotter pin connection to establish a pivoting connection therebetween and is attached to the driveshaft 66 through a pair of fasteners that are spaced longitudinally from one another. The dispositions of the brackets 64 between the torque arms 60 and the driveshaft 66 is advantageous because it provides for a vertical offset between the bottoms of the torque arms 60 and the driveshaft 66. This offset ensures a clearance between the lower edges of the photovoltaic panels 24 and the driveshaft 66 during the course of the kinematic motion of driving the system while also reducing the amount of vertical movement of the driveshaft 66 when rotating the photovoltaic panels 24. Thus, a “gap” is not required between photovoltaic panels 24 directly above the driveshaft 66 as is included in many other known solar tracking systems. In other words, the exemplary sub-assemblies 22 include a constant row of photovoltaic panels 24 with increased electricity generation and improved aerodynamics, which results in a reduced wind turbulence on the sub-assemblies 22. The additional photovoltaic panels 24 may be used, for example, to power battery backups or additional electrical equipment for the system.

As discussed above and shown in FIG. 1, the driveshaft 66 extends longitudinally between and interconnects all of the sub-assemblies 22. The driveshaft 66 is attached to an actuator 26 (such as an electric, hydraulic, or pneumatic motor) which is controlled by a control box (not shown) for moving the driveshaft 66 in a longitudinal direction. Movement of the driveshaft 66 in the longitudinal direction causes the torque arms 60 to pivot about the middle torque tubes 36a, thereby rotating all of the torque tubes 36a, 36b of all of the sub-assemblies 22 simultaneously. This re-orients all of the photovoltaic panels 24 relative to the base 30. As such, a single actuator 26 is able to simultaneously re-orient the photovoltaic panels 24 of all of the sub-assemblies, thus allowing the photovoltaic panels 24 to “follow the sun” through the sky to maximize the amount of solar rays harnessed by the solar tracker assembly 20 during each day. Although the exemplary solar tracker assembly 20 includes nine sub-assemblies 22, it should be appreciated that any desirable number of sub-assemblies 22 may be attached to one another through the drive shaft 66.

Each of the sub-assemblies 22 is also configured such that the torque arm 60 extends generally perpendicularly relative to the photovoltaic panels 24. During heavy winds, this orientation of the torque arm 60 allows it to provide support to the frame structure 28 for resisting wind forces acting on the photovoltaic panels 24.

The driveshaft 66, bracket 64, torque arm 60, and middle torque tube 36a may all be added to an existing solar assembly by cutting gaps into the torque tubes of those assemblies and connecting the middle torque tubes 36a to the existing torque tubes at the gaps. As such, certain aspects of the present invention may be employed to improve an existing solar tracker assembly.

Obviously, many modifications and variations of the present invention are possible in light of the above teachings and may be practiced otherwise than as specifically described while within the scope of the appended claims.

1. A solar panel assembly, comprising:
a plurality of sub-assemblies which are spaced from one another in a longitudinal direction;
each of said sub-assemblies including at least two torque tubes which extend in a lateral direction which is generally transverse to said longitudinal direction and wherein each of said sub-assemblies includes a plurality of laterally spaced rails coupled with said torque tubes for supporting a plurality of solar panels or reflectors thereon and wherein rotation of said at least one torque tube rotates the solar panels or reflectors mounted on said rails;
at least one torque arm joined with and extending transversely away from one of said torque tubes of each sub-assembly;
a driveshaft extending longitudinally between said plurality of sub-assemblies and being moveable in said longitudinal direction for rotating the solar panels or reflectors via said torque arms and said torque tubes and said rails; and
wherein said torque tubes are generally cylindrical in shape and adjacent torque tubes of each sub-assembly are co-axially joined in an end-to-end relationship with one another.

2. The solar panel assembly as set forth in claim 1 wherein adjacent ones of said torque tubes have adjacent longitudinal ends with plates attached to said longitudinal ends and wherein said plates of said adjacent torque tubes are joined together.

3. The solar panel assembly as set forth in claim 2 wherein said plates of said adjacent torque tubes are joined together with fasteners.

4. The solar panel assembly as set forth in claim 2 wherein said plates are welded to said longitudinal ends of said torque tubes.

5. The solar panel assembly as set forth in claim 1 further including a plurality of photovoltaic panels supported on said laterally spaced rails of each of said sub-assemblies.

6. The solar panel assembly as set forth in claim 5 wherein each of said sub-assemblies includes a photovoltaic panel disposed directly above said driveshaft which extends between said sub-assemblies.

7. The solar panel assembly as set forth in claim 5 and wherein said torque arms of said sub-assemblies extend generally transversely to said photovoltaic panels.

8. The solar panel assembly as set forth in claim 1 wherein said rails are joined with said torque tubes via brackets.

9. The solar panel assembly as set forth in claim 8 wherein each of said brackets has at least one generally arcuate edge that is joined with one of said torque tubes.

10. The solar panel assembly as set forth in claim 9 wherein each of said brackets has a pair of generally arcuate edges.

11. The solar panel assembly as set forth in claim 10 wherein said arcuate edges of said brackets are welded to said torque tubes.

12. The solar panel assembly as set forth in claim 1 further including a plurality of bearings which rotatably support said torque tubes.

13. The solar panel assembly as set forth in claim 12 wherein each of said bearings includes a pair of races with generally spherically shaped outer surfaces and a pair of shells with generally spherically shaped inner surfaces and wherein said races are slidably supported within said shells.

14. The solar panel assembly as set forth in claim 12 wherein each of said sub-assemblies includes a plurality of support posts which support said bearings.

15. The solar panel assembly as set forth in claim 1 further including an actuator operably coupled with said driveshaft for moving said driveshaft in a longitudinal direction to simultaneously rotate said torque tubes of said plurality of sub-assemblies through said torque arms.

16. A solar assembly, comprising:
a plurality of longitudinally spaced solar sub-assemblies;
each of said sub-assemblies including at least two first torque tubes which extend in spaced and parallel relationship with one another;
a plurality of rails attached with said first torque tubes for supporting a plurality of solar panels or reflectors such that rotation of said torque tubes reorients the solar panels or reflectors mounted on said rails;
each of said sub-assemblies further including a second torque tube which is shorter than said first torque tubes;
said first and second torque tubes being generally cylindrical in shape and being co-axially joined together in end-to-end relationship with one another;
a torque arm fixed with and extending transversely away from each of said second torque tubes; and
a driveshaft fixed with said torque arms of said sub-assemblies and being movable in a longitudinal direction for rotating said first and second torque tubes to reorient the solar panels or reflectors.

17. The solar assembly as set forth in claim 16 wherein said first and second torque tubes have adjacent longitudinal ends with plates attached thereto and wherein said plates of said second torque tubes are coupled with said plates at said longitudinal ends of said first torque tubes.

18. The solar panel assembly as set forth in claim 17 wherein said plates of said second torque tube are coupled with said plates of said first torque tubes with fasteners.

19. The solar panel assembly as set forth in claim 17 wherein said plates are welded to said longitudinal ends of said first and second torque tubes.

20. The solar panel assembly as set forth in claim 16 further including a plurality of photovoltaic panels supported on said rails of said sub-assemblies.
